(19) United States
(12) Patent Application Publication
(10) Pub. No.: US 2026/0191731 A1
(43) Pub. Date: Jul. 9, 2026

(54) Eye Massager

(71) Applicant: Ningbo Fulljoy Electronic Technology Co., Ltd., Zhejiang (CN)

(72) Inventor: Liangfei CHEN, Zhejiang (CN)

(73) Assignee: Ningbo Fulljoy Electronic Technology Co., Ltd., Zhejiang (CN)

(21) Appl. No.: 19/012,461

(22) Filed: Jan. 7, 2025

(51) Int. Cl. A61H 9/00

(52) U.S. Cl. CPC A61H 9/0092; A61H 2201/0207; A61H 2201/1246; A61H 2201/1604; A61H 2201/165; A61H 2201/169; A61H 2205/024; A61H 2205/028

(57) ABSTRACT

The present disclosure provides an eye massager, which is designed to have a massager bracket and a cover, wherein the massager bracket is used for supporting the whole eye massager, and the cover is used for covering the eyes of a user. A liner is disposed between the cover and the massager bracket, and the edge of the liner is connected to the massager bracket. The cover comprises an inner fabric and an outer fabric. The inner fabric and the liner are sewed and connected by at least one first connecting strip, the inner fabric and the outer fabric are sewed and connected by second suture to form an accommodating cavity, and an inlet communicated with the accommodating cavity is formed on the inner fabric.

### TECHNICAL FIELD

The present disclosure relates to an eye massager, in particular to an eye massager with an air bag and a double-layer cushion material.

### BACKGROUND

With the development of science and technology and the increasing pressure of people's life, eye fatigue has become a common problem. In order to relieve eye fatigue, various eye massagers came into being. Eye massager is a medical device that promotes eye blood circulation and relieves eye fatigue by physical means, such as massage and hot compress.

However, in the existing eye massagers, such as international publication No. WO2014067247A1, U.S. Pat. No. 1,042,666 and U.S. Patent Application No. US20240285438A1, each cover in the above inventions is simply a layer of padding material disposed on the massager bracket, which may be displaced only due to the slight movement of the user or slight shaking of the massager during use. However, the padding displaces with the massager, and because the connection mode between the padding and the massager bracket is simple, the area covered by the padding deviates from the user's eyes, which affects the massage effect. At the same time, the single-layer massage eye mask has obvious pressure on eyes during the massage process, thus reducing the use experience.

Although there are eye massagers with double-layer eye masks on the market, the eye masks of this kind of eye massagers are likely to open between the two layers of cover fabric and expose the air nozzle holes and connecting wires inside them, which is not practical and beautiful enough.

### SUMMARY

The massager body of the eye massager of the present disclosure is designed to have a massager bracket and a cover, wherein the massager bracket is used for supporting the whole eye massager, and the cover is used for covering the eyes of a user. The purpose of this design is to make the massager more stably fixed on the user's head, reduce the possible displacement during use, and thus improve the massage effect. A liner is disposed between the cover and the massager bracket, and the edge of the liner is connected to the massager bracket. The cover includes an inner fabric and an outer fabric, the inner fabric and the liner are sewed and connected by at least one first connecting strip, and the inner fabric and the outer fabric are sewed and connected by a second suture to form an accommodating cavity into which fillers can be put; and the inner fabric is provided with an inlet communicated with the accommodating cavity;

The liner is provided with an opening communicated with the inlet, and the first connecting strip is disposed around the opening to form a barrier. The first connecting strip is connected to the inner fabric and is spaced from the edge of the cover to form a turning-over part on the cover that can be turned over relative to the liner.

### BRIEF DESCRIPTION OF DRAWINGS

The accompanying drawings, which constitute a part of this application, are used to provide a further understanding of the present disclosure, and the illustrative embodiments of the present disclosure and the descriptions thereof are used to explain the present disclosure, and do not constitute undue limitations on the present disclosure. In the attached drawings:

FIG. 1 shows a structural schematic diagram of an embodiment of an eye massager according to the present disclosure;

FIG. 2 shows a schematic diagram of the internal structure of the eye massager in FIG. 1;

FIG. 3 shows a partial structural schematic diagram of the massager bracket in FIG. 2;

FIG. 4 shows the structural schematic diagram of the cover and liner in FIG. 2;

FIG. 5 shows a schematic diagram of the position of the first connecting strip and the second suture between the cover and the liner in FIG. 4;

FIG. 6 shows another schematic diagram of the structure of the cover and the liner in FIG. 4;

FIG. 7 shows another schematic diagram of the structure of the cover and the liner in FIG. 6;

FIG. 8 shows a schematic diagram of the connection structure between the inner fabric and the liner in FIG. 6;

FIG. 9 is a schematic view showing the expanded state of the liner in FIG. 5;

FIG. 10 shows the structural schematic diagram of the sponge layer and the heating layer in FIG. 6;

FIG. 11 shows a structural schematic diagram of an embodiment of the air bag of the present disclosure;

the above drawings include the following reference signs:

Massager body (10); Massager bracket (100); Cover (200); Liner (300); First suture (400); Second suture (500); Headband (600); First bracket (110); Second bracket (120); Hinge (130); Inlet (220); Inner fabric (240); Outer fabric (250); Sponge layer (260); Air bag (270); Heating layer (280); First air cushion (271); Second air cushion (272); Air nozzle (273); Side air bag (274); Channel (275); Air pump assembly (290); Opening (310); Connecting edge (320); Covering edge (330).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, the applications or uses thereof. Based on the embodiments in the present disclosure, all other embodiments obtained by those skilled in the art without creative work shall belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

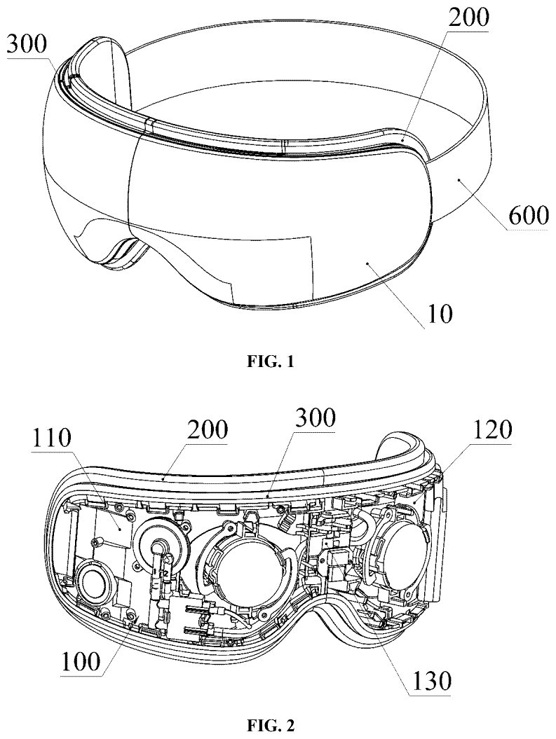

As shown in FIGS. 1-7, the present disclosure provides an eye massager, which includes a massager body 10; a cover 200 that is adapted for covering the eyes of users and is provided with an accommodating cavity and an inlet 220 communicated with the accommodating cavity; a liner 300 disposed between the cover 200 and the massager body 10, wherein the edge of the liner 300 is connected to the massager body 10, the liner 300 and the cover 200 are connected by sewing at least one first connecting strip, the liner 300 is provided with an opening 310 communicated with the inlet 220, and the first connecting strip is disposed around the opening 310 to form a barrier.

The liner 300 and the cover 200 are connected by a first suture 400, which constitutes the first connecting strip. In other embodiments, the liner 300 and the cover 200 can also be connected by gluing or hot-pressing fusion to form the first connecting strip.

The first suture 400 can be a continuous closed-loop suture, or a plurality of continuous or intermittent sutures disposed in the circumferential direction, which is mainly used to form a barrier between the cover 200 and the massager bracket 100 from the outside, so as to avoid exposing wires or components therein and affecting the appearance.

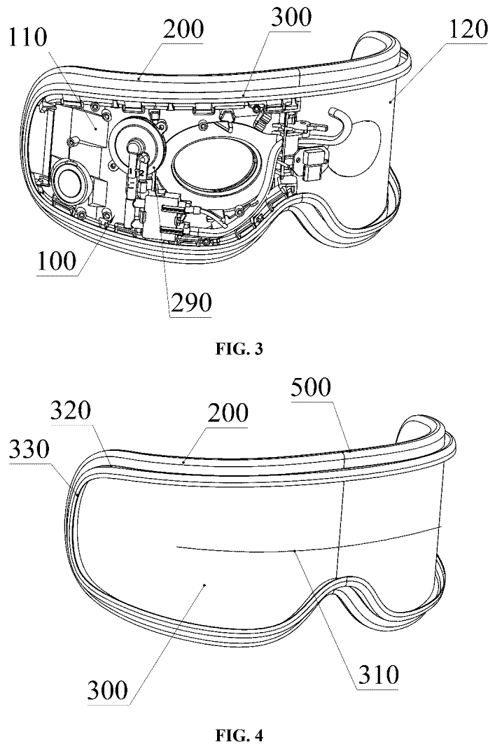

As shown in FIGS. 2 and 3, the massager body 10 includes a massager bracket 100 for installing various massager parts. The massager bracket 100 includes a first bracket 110 and a second bracket 120 hinged with the first bracket 110. A hinge 130 is provided between the first bracket 110 and the second bracket 120, and the first bracket 110 and the second bracket 120 are hinged by the hinge 130. Headbands 600 for fixing the massager bracket 100 on the head are sewn on both sides of the liner 300.

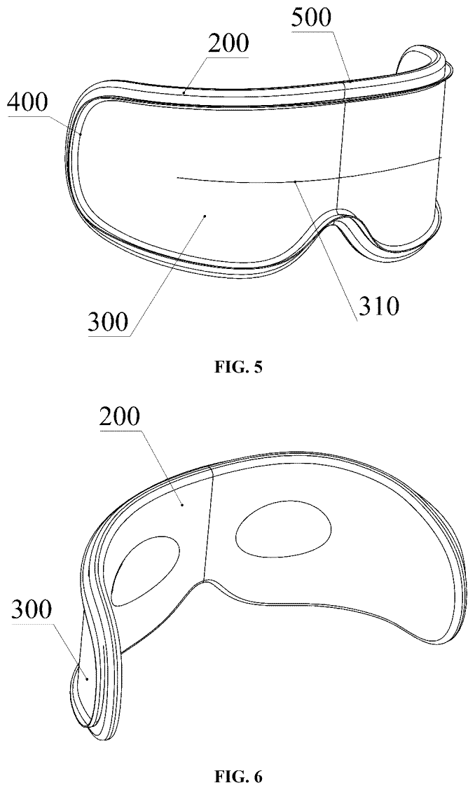

As shown in FIGS. 5-8, the first suture 400 is connected to the cover 200 and is spaced from the edge of the cover 200 to form a turning-over part of the cover 200 that can be turned over relative to the liner body 300. This design makes the connection between the cover 200 and the massager bracket 100 more flexible, and there is a certain space between the cover 200 and the massager bracket 100, so that the cover 200 will not be displaced due to slight movement of the user or slight shaking of the massager, thus ensuring the accuracy and stability of the eye coverage area of the user and improving the massage effect.

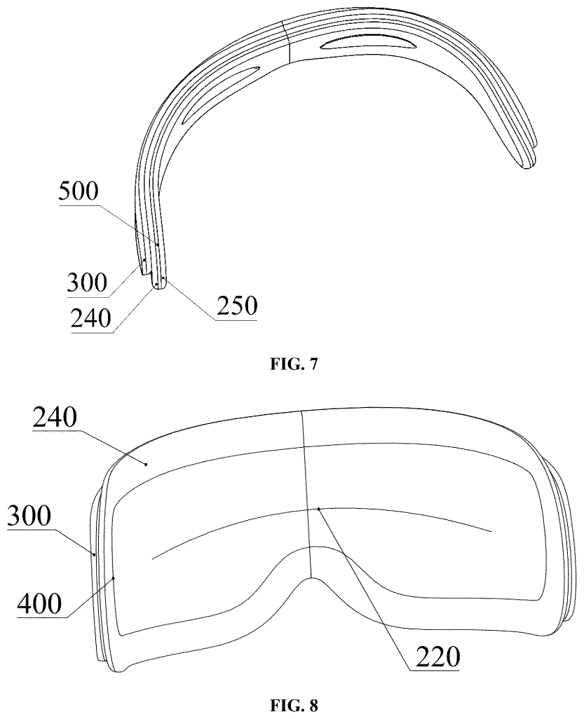

As shown in FIGS. 6-8, the cover 200 includes an inner fabric 240 and an outer fabric 250, the inner fabric 240 is connected with the liner 300 by at least one first suture 400, and the inner fabric 240 and the outer fabric 250 are connected by a second suture 500 to form the receiving cavity; the inner fabric 240 is provided with an inlet 220 communicated with the receiving cavity, wherein, the liner 300, the inner fabric 240 and the outer fabric 250 may be provided with hollowed-out areas corresponding to the eyes of the user according to actual design requirements, or they may not be provided with hollowed-out areas to provide a flat contact surface, while the inlet 220 on the inner fabric 240 or the opening 310 on the liner 300 may overlap with the hollowed-out areas or are staggered relative to the hollowed-out areas. When they overlap, the hollowed-out areas may be configured as a part of the opening 310 or the inlet 220, which is convenient for placing required components.

The inner fabric 240 and the outer fabric 250 can also be connected by gluing or hot-pressing fusion.

The existing eye massager lacks the targeted massage for the peripheral areas of the eyes, such as temples, and cannot completely relieve eye fatigue. At the same time, the structure of the cover 200 of the eye massager is relatively simple, and the integration of various functions such as hot compress can not be realized, which limits the improvement of massage effect.

A sponge layer 260 and an air bag 270 are disposed in the accommodating cavity, and an air nozzle 273 is disposed on the air bag 270. The inlet 220 is formed by cutting the inner fabric 240. When the air bag 270 is placed in the accommodating cavity, the air nozzle 273 extends to the outside through the inlet 220 and the opening 310. A heating layer 280 is also disposed in the accommodating cavity, and the heating layer 280 is disposed between the outer fabric 250 and the sponge layer 260.

As shown in FIG. 11, the air bag 270 includes a first air cushion 271 and a second air cushion 272. The first air cushion 271 includes two side air bags 274 corresponding to the temporal parts of the human body and a channel 275 communicating the two side air bags 274. The second air cushion 272 is disposed between the two side air bags 274, and each of the first air cushion 271 and the second air cushion 272 has an air nozzle 273 respectively. The massager bracket 100 is provided with an air pump assembly 290 for supplying air to the air bag 270, and the air nozzle 273 of the first air cushion 271 is disposed on the channel 275. When the air bag 270 is placed in the accommodating cavity, the channel 275 is disposed at a position in the accommodating cavity corresponding to the inlet 220.

In some embodiments, the air pump assembly 290 includes a miniature air compressor mounted on the massager bracket 100, and its output end is communicated with the air nozzle 273 of the air bag 270 through a hose. The air bag 270 is made of PVC. The thickness of the first air cushion 271 and the second air cushion 272 ranges from 0.2 to 0.5 mm, the diameter of the side air bag 274 ranges from 20 to 30 mm, and the diameter of the channel 275 ranges from 10 to 15 mm. The heating layer 280 is made of a carbon fiber heating film, with a working voltage of 12V DC power supply and a heating power of 5 W. The sponge layer 260 is made of memory sponge with a thickness ranging from 5 to 10 mm. When the eye massager of the present disclosure is used, firstly, the power supply is turned on through a control panel, and the miniature air compressor is started to inflate the air bag 270, and at the same time, the heating layer 280 is started to apply heat to the eyes. Then different massage modes can be selected as needed, such as squeezing massage mode and vibration massage mode, so as to realize various massage effects on the eyes and relieve eye fatigue.

This design enables the air bag 270 to fit the user's head, especially the eyes and temples, and improves the use experience, so that the eye massager can massage temples and eyes at the same time, and the functionality of the product is increased. At the same time, the air nozzle 273 of the air bag 270 is centrally disposed at the opening 310 of the cover 200, which is also the middle area of the massager bracket 100, thereby effectively reducing the design thickness of the two sides of the massager.

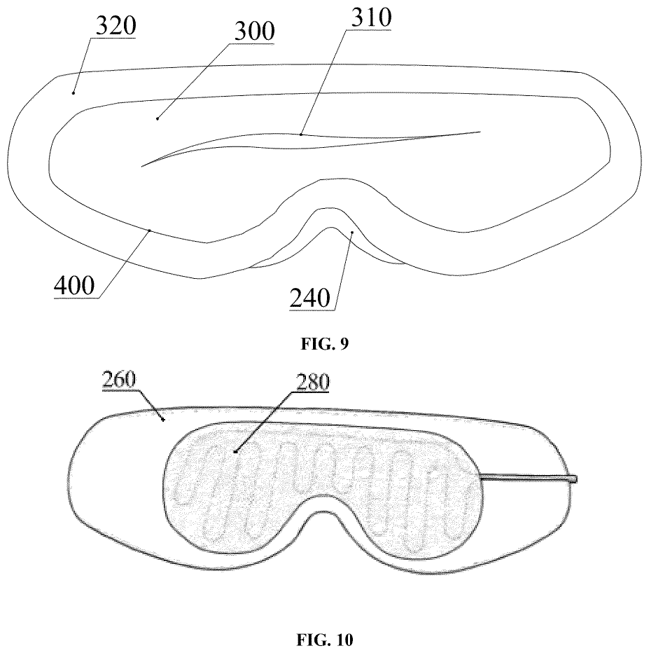

As shown in FIGS. 2 and 9, the second suture 500 is respectively connected to the edges of the inner fabric 240 and the outer fabric 250, the second suture 500 on the inner fabric 240 is disposed on the periphery of the first suture 400, and the first suture 400 on the inner fabric 240 is disposed on the periphery of the opening 310. The cover 200 covers the liner body 300, and the area of the cover 200 is larger than that of the massager bracket 100.

The first suture 400 is connected to the inner area of the liner 300 and leaves a gap from the edge of the liner 300 to form a connecting edge 320, which is connected to the edge of the massager bracket 100. The massager bracket 100 has a back surface closely attached to the liner 300 and a front surface opposite to the back surface. The edge of the connecting edge 320 is bent to form a covering edge 330, which is connected to the edge of the front surface of the massager bracket 100.

As shown in FIGS. 2 and 3, the covering edge 330 is connected to the edge of the front of the massager bracket 100 by any means of sewing, gluing or hot-pressing fusion. When gluing is used, the covering edge 330 can be bonded to the edge of the front surface of the massager bracket 100 by using glue with good adhesive properties such as epoxy resin glue and silicone rubber. When sewing is adopted, a sewing machine can be used to sew the covering edge 330 with the edge of the front surface of the massager bracket 100. With a fusion mode, the covering edge 330 and the edge of the front surface of the massager bracket 100 can be fused and bonded by high-frequency heating.

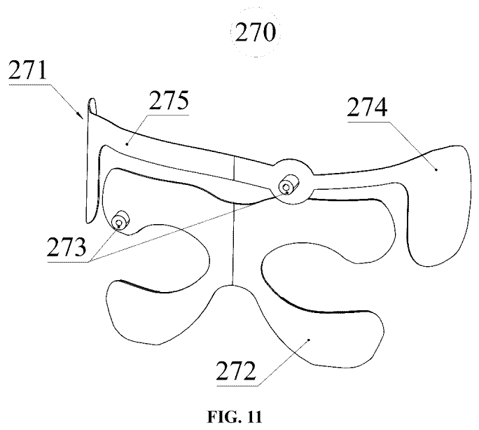

In some specific embodiments of manufacturing the above-mentioned eye massager, the following methods are provided: 1, the massager bracket 100, liner 300, heating sheet, sponge layer 260, inner fabric 240 and outer fabric 250 and the like are prepared, wherein the massager bracket 100 can be made of an ABS material, which has good durability and comfort, and both the inner fabric 240 and the outer fabric 250 can be made of soft cotton material; 2, as shown in FIGS. 8 and 9, the liner 300 is sewn and connected to the inner fabric 240 with cuts, the inner fabric 240 is sewn and connected with the liner 300 by at least one first suture 400, which is made of high-strength polyester thread to ensure the firmness of the connection; 3, according to the design requirements of the eye massager and using the intelligent laser cutting system, the liner 300, the inner fabric 240, the outer fabric 250 and other materials are cut into the required shapes and quantities of the cover 200; 4, a heating sheet is attached to the sponge layer 260 by means of a double-sided adhesive tape, as shown in FIG. 10; 5, after the sponge layer 260, the inner fabric 240 and the outer fabric 250 are stacked and their edges are aligned, the edges thereof are sutured along the rims, the inner fabric 240 and the outer fabric 250 are sewn and connected by a second suture 500 to form the accommodating cavity, and the second suture 500 is also made of high-strength polyester thread; 6, the air bag 270 is installed into the cover 200 from the cutting opening, so as to facilitate the air nozzle 273 to protrude from the cutting opening; 7, the liner 300 can be made of soft silica gel, cotton fabric and other materials, and its edge is covered to the edge of the massager bracket 100 by gluing.

From the above description, it can be seen that the above embodiments of the present disclosure have achieved the following technical effects: a double-layer eye mask structure is adopted, the cover 200 can be provided with an air bag 270 and a sponge layer 260 having a buffering function, which can effectively reduce the eye pressure and improve the use comfort; the cover 200 and the liner body 300 are connected in a reliable way, such as sewing, to avoid opening and exposing the internal structure during use; at the same time, the air nozzle 273 of the air bag 270 and the wires of the heating sheet pass through the opening 310 inside the first suture 400, and the first suture 400 forms a barrier to ensure aesthetics and use experience; the eye mask and the massager bracket 100 are connected in a reliable way, for example the edge of the liner 300 is connected to the massager bracket 100, the liner 300 and the cover 200 are connected by stitching, and the suture is disposed around the opening 310 to form a barrier, so that the cover 200 can be turned over relative to the liner 300, which increases the activity space of the cover 200 and improves the use flexibility.

The existing eye massager mainly includes a massager bracket 100 and a cover 200. The massager bracket 100 is used to fix the equipment, and the cover 200 is used to cover the eyes of the user. The cover 200 is usually sewn and connected by an inner fabric 240 and an outer fabric 250, and the inner fabric 240 is provided with an inlet 220 communicated with the accommodating cavity. A sponge layer 260 and an air bag 270 can be disposed in the accommodating cavity, an air nozzle 273 is disposed on the air bag 270, and the inlet 220 is formed by cutting the inner fabric 240. When the air bag 270 is placed in the accommodating cavity, the air nozzle 273 extends to the outside through the inlet 220 and the opening 310.

In the description of the present disclosure, it should be appreciated that the orientation or positional relationship indicated by orientation words such as “front, back, upper, lower, left, right”, “lateral, vertical, horizontal” and “top, bottom” are usually based on the orientation or positional relationship shown in the attached drawings, just for the convenience of describing the present disclosure and simplifying the description. Unless otherwise stated, these orientation words do not indicate or imply that the device or element referred to must have a specific orientation or be constructed and operated in a specific orientation, therefore they cannot be construed as limiting the scope of protection of the present disclosure. The orientation words “inside and outside” refer to the inside and outside relative to the outline of each component itself.

For the convenience of description, spatially relative terms such as “above”, “on”, “on the upper surface of” and “upper” can be used here to describe the spatial positional relationship between a device or feature as shown in the drawings and other devices or features. It should be appreciated that spatially relative terms are intended to encompass different orientations in use or operation in addition to the orientation of the device depicted in the drawings. For example, if the devices in the drawings are inverted, devices described as “above” or “on” other devices or structures will be positioned as “below” or “under” other devices or structures. Thus, the exemplary term “above” can include both orientation of “above” and “below”. The device can also be positioned in other different ways (rotated by 90 degrees or in other orientations), and the spatial relative description used here is explained accordingly.

In addition, it should be noted that the words “first” and “second” are used to define parts for the convenience of distinguishing the corresponding parts. Unless otherwise stated, the above words have no special meaning, and thus they cannot be construed as limiting the protection scope of the present disclosure.

What has been described above is only the preferred embodiment of the present disclosure, and it is not intended to limit the present disclosure. For those skilled in the art, the present disclosure may have various modifications and changes. Any modification, equivalent substitution, improvement and the like made within the spirit and principle of the present disclosure shall fall into the protection scope of the present disclosure.

What is claimed is:

1. An eye massager, comprising:
a massager body; and
a cover that is adapted for covering eyes of a user and is provided with an accommodating cavity into which fillers can be put and an inlet communicated with the accommodating cavity; and
a liner disposed between the cover and the massager body, wherein an edge of the liner is connected to the massager body, the liner and the cover are connected by at least one first connecting strip, and the liner is provided with an opening communicated with the inlet;
wherein, the first connecting strip is configured for restricting the liner from separating from the cover, and the first connecting strip is disposed around the opening to form a barrier.

2. The eye massager according to claim 1, wherein the first connecting strip is connected to the cover and is spaced from an edge of the cover to form a turning-over part on the cover that can be turned over relative to the liner.

3. The eye massager according to claim 2, wherein the cover comprises an inner fabric and an outer fabric; and the inner fabric and the liner are connected by stitching through at least one first connecting strip, and the inner fabric and the outer fabric are connected by stitching through a second suture to form the accommodating cavity; and the inner fabric is provided with an inlet communicated with the accommodating cavity.

4. The eye massager according to claim 3, wherein a sponge layer and an air bag are disposed in the accommodating cavity, an air nozzle is disposed on the air bag, and the inlet is made of the inner fabric by cutting; and when the air bag is placed in the accommodating cavity, the air nozzle extends to the outside through the inlet and the opening.

5. The eye massager according to claim 4, wherein a heating layer is further disposed in the accommodating cavity, and the heating layer is disposed between the outer fabric and the sponge layer.

6. The eye massager according to claim 4, wherein the air bag comprises a first air cushion and a second air cushion, wherein the first air cushion comprises two side air bags corresponding to the temple parts of a human body and a channel for communicating the two side air bags, and the second air cushion is disposed between the two side air bags, wherein each of the first air cushion and the second air cushion has an air nozzle.

7. The eye massager according to claim 6, wherein a main body of the massager is provided with an air pump assembly for supplying air to the air bag, and the air nozzle of the first air cushion is disposed on the channel; and when the air bag is placed in the accommodating cavity, the channel is disposed at a position in the accommodating cavity corresponding to the inlet.

8. The eye massager according to claim 3, wherein the second suture is respectively connected to the edges of the inner fabric and the outer fabric; and the second suture on the inner fabric is disposed on the periphery of the first connecting strip, and the first connecting strip on the inner fabric is disposed on the periphery of the opening.

9. The eye massager according to claim 1, wherein the liner and the cover are connected by a first suture, and the first suture constitutes the first connecting strip.

10. The eye massager according to claim 1, wherein the massager body comprises a massager bracket, and the first connecting strip is connected to an inner area of the liner and is spaced from the edge of the liner to form a connecting edge that is connected to the edge of the massager bracket.

11. The eye massager according to claim 10, wherein the massager bracket has a back surface closely attached to the liner and a front surface opposite to the back surface; and an edge of the connecting edge is bent to form a covering edge, which is connected to an edge of the front surface of the massager bracket.

12. The eye massager according to claim 11, wherein the covering edge is connected to the edge of the front surface of the massager bracket by any means of sewing, gluing or hot-pressing fusion.

13. The eye massager according to claim 10, wherein the cover covers the liner, and the cover has an area larger than that of the massager bracket.

14. The eye massager according to claim 10, wherein the massager bracket comprises a first bracket and a second bracket hinged with the first bracket, a hinge is disposed between the first bracket and the second bracket, and the first bracket and the second bracket are hinged by the hinge.

15. The eye massager according to claim 1, wherein the liner and the cover are connected by gluing or hot-pressing fusion to form the first connecting strip.

16. An eye massager, comprising:
a massager body; and
a liner connected to the massager body; and
a cover comprising an inner fabric and an outer fabric, wherein the inner fabric and the liner are connected by at least one first connecting strip, and the inner fabric and the outer fabric are connected by a second connecting strip to form an accommodating cavity into which fillers can be put, wherein the inner fabric is provided with an inlet communicated with the accommodating cavity;
wherein, the liner is provided with an opening communicated with the inlet, and the first connecting strip is disposed around the opening to form a barrier; and the first connecting strip is connected to the inner fabric and is spaced from an edge of the cover to form a turning-over part on the cover which can be turned over relative to the liner.

17. The eye massager according to claim 16, wherein the liner and the cover are connected by any means of sewing, gluing or hot-pressing fusion to form the first connecting strip.

18. The eye massager according to claim 16, wherein a sponge layer and an air bag are disposed in the accommodating cavity, an air nozzle is disposed on the air bag, and the inlet is made of the inner fabric by cutting; and when the air bag is placed in the accommodating cavity, the air nozzle extends to the outside through the inlet and the opening; and the air bag comprises a first air cushion and a second air cushion, wherein the first air cushion comprises two side air bags corresponding to the temple parts of a human body and a channel for communicating the two side air bags, and the second air cushion is disposed between the two side air bags, wherein each of the first air cushion and the second air cushion has an air nozzle, and the air nozzle of the first air cushion is disposed on the channel.

19. The eye massager according to claim 16, wherein the massager body comprises a massager bracket which comprises a first bracket and a second bracket hinged with the first bracket, a hinge is disposed between the first bracket and the second bracket, and the first bracket and the second bracket are hinged by the hinge.

20. The eye massager according to claim 19, wherein the first connecting strip is connected to an inner area of the liner and is spaced from the edge of the liner to form a connecting edge, which is connected to the edge of the massager bracket; and the massager bracket has a back surface closely attached to the liner and a front surface opposite to the back surface; and the connecting edge is bent to form a covering edge, and the covering edge is connected to the edge of the front surface of the massager bracket by gluing.
